(19) United States
(12) Patent Application Publication
(10) Pub. No.: US 2006/0136475 A1
(43) Pub. Date: Jun. 22, 2006

(54) Secure data transfer apparatus, systems, and methods

(76) Inventors: Soumen Karmakar, Hillsboro, OR (US); Benjamin Metzler, Beaverton, OR (US); Jasmeet Chhabra, Hillsboro, OR (US); Nandakishore Kushalnagar, Portland, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/018,850

(22) Filed: Dec. 21, 2004

(51) Int. Cl. G06F 17/00

(52) U.S. Cl. 707/102

(57) ABSTRACT

Apparatus and systems, as well as methods and articles, may operate to store a data field in a data file, wherein the data field is associated with one or more data packets received at a node on a first network, and to transfer the data file between the node on the first network and a node on a second network. The data file may be transferred across a wired communications link utilizing a file transfer protocol not associated with a network protocol stack.

### TECHNICAL FIELD

Various embodiments described herein relate to electronic data communications generally, including apparatus, systems, and methods used to transfer data files.

### BACKGROUND INFORMATION

A wireless mesh networking topology may provide a convenient architecture for constructing a sensor network. On the other hand, some security risks associated with wireless networking, including access to the transmission medium by an unauthorized workstation within a reception range of the network, are well-known. For example, an intruder may exploit characteristics of a switched, open-systems protocol to gain unauthorized access to a network, or to deliver malicious data or code to the network. Traditional approaches to security, including virtual private networks (VPNs) and firewalls, may be resource-intensive and may not be practical for a sensor network operating with low power components and non-standard operating systems. In some cases, sensor data may not be compatible with transmission control protocol/internet protocol (TCP/IP) methods, including file transfer protocol (FTP) and TCP/IP-based email. A combination of these factors may present a challenge to the transfer of data from wireless sensor networks to secure corporate networks.

### BRIEF DESCRIPTION OF THE DRAWINGS

FIG. 1 is a block diagram of an apparatus and a system according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

Some embodiments disclosed herein may operate to remove security-compromised protocol elements from a data stream and to transfer data from an insecure sensor network to a node on a secure network, over a secure link.

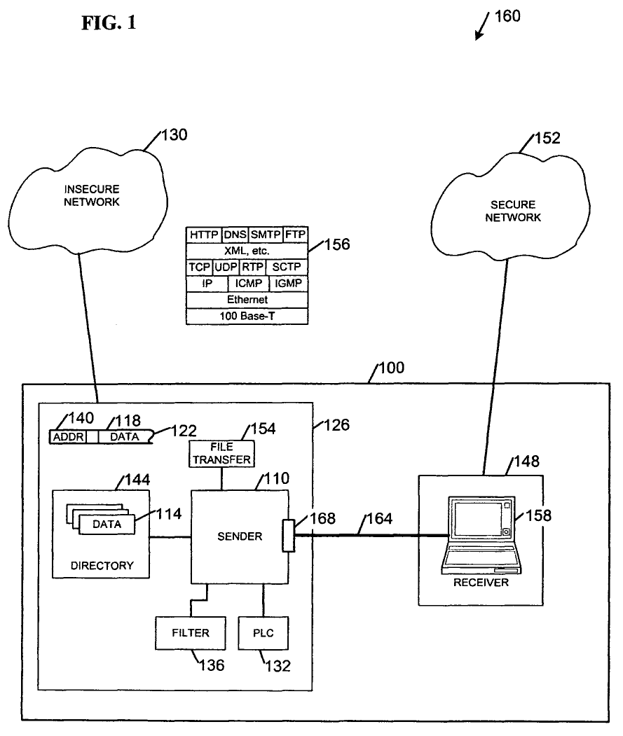

FIG. 1 comprises a block diagram of an apparatus 100 and a system 160 according to various embodiments of the invention. The apparatus 100 may include a sender module 110 to transfer one or more stored data files 114, including one or more data fields 118 associated with data packets 122 received at a node 126 on a first network 130. The network 130 may comprise a wireless sensor network, for example, perhaps one that exchanges data packets according to an Institute of Electrical and Electronic Engineers (IEEE) 802.11 specification. The apparatus 100 may also include one or more programmable logic controllers (PLCs) 132 coupled to the sender module 110 to provide the data packets 122.

For further information regarding 802.11 standards, please consult “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related amendments.

The apparatus 100 may further include a filter 136 coupled to the sender module 110 to isolate the data field 118 from one or more protocol elements 140 associated with the data packets 122. Data thus isolated from the protocol elements utilized to switch packets through a network may be less likely to be switched though the network for malicious purposes.

In some embodiments, the apparatus 100 may include a directory 144 coupled to the sender module 110 to receive and store the data file 114 for subsequent transmission. A file transmission process may poll the directory 144 or may operate in an interrupt-driven mode to determine that a newly-created data file 114 is ready for transmission.

The data files 114 may be transferred between the node 126 on the first network 130 and a node 148 on a second network 152 utilizing a file transfer protocol 154 not associated with a network protocol stack 156 (e.g., a file transfer protocol such as Kermit, or zmodem). The apparatus 100 may also include a receiver module 158 coupled to the sender module 110 to receive the data file 114, perhaps using the wired communications link 164.

For additional information regarding the Kermit protocol, please refer to The Kermit Project website, Columbia University (New York City), at http://www.columbia.edu/kermit/. For further information regarding the zmodem protocol, please refer to the technical document “The Zmodem Inter Application File Transfer Protocol” by Chuck Forsberg, at http://pauillac.inria.fr/˜doligez/zmodem/zmodem.txtoverview.

Other embodiments may be realized. For example, a system 160 may include an apparatus 100 comprising a sender module 110, a receiver module 158, and a wired communications link 164 coupled to the sender module 110 and to the receiver module 158. The wired communications link 164 may comprise a twisted pair medium, or a coaxial cable, among others.

The system 160 may also include a secure port 168 associated with the sender module 110, the receiver module 158, or both. The secure port 168 may be coupled to the wired communications link 164, and access to the secure port 168 may be limited to applications implementing a selected file transfer protocol 154. Thus, security associated with the secure port 168 may derive from limiting access to trusted applications that operate to transfer non-switchable data utilizing a non-switchable protocol. In some embodiments of the system 160, the secure port 168 may comprise a universal serial bus (USB) port, or may utilize Electronic Industries Association (EIA) 232 standard voltage levels and signaling, for example. For additional information about the USB, please refer to the Universal Serial Bus Specification Version 2.0 (2000), published by USB-IF; 5440 SW Westgate Drive, Suite 217; Portland, Oreg. 97221. For additional information about the EIA-232 standard (also known as RS-232), please refer to “EIA232E—Interface Between Data Terminal Equipment and Data Circuit-Terminating Equipment Employing Serial Binary Data Interchange” published by the Electronic Industries Association, January 1991, and related amendments.

The apparatus 100; sender module 110; stored data file 114; data field 118; data packet 122; nodes 126, 148; networks 130, 152; programmable logic controller (PLC) 132; filter 136; protocol element 140; directory 144; file transfer protocol 154; network protocol stack 156; receiver module 158; system 160; communications link 164; and secure port 168 may all be characterized as “modules” herein.

Such modules may include hardware circuitry, single processor circuits, multi-processor circuits, memory circuits, software program modules and objects, firmware and combinations thereof, as desired by the architect of the apparatus 100 and system 160 and as appropriate for particular implementations of various embodiments. For example, such modules may be included in a system operation simulation package such as a software electrical signal simulation package, a power usage and distribution simulation package, a capacitance-inductance simulation package, a power/heat dissipation simulation package, a signal transmission-reception simulation package, or a combination of software and hardware used to simulate the operation of various potential embodiments.

It should also be understood that the apparatus and systems of various embodiments can be used in applications other than secure file transfers between wired network nodes, and various embodiments are not to be so limited. The illustrations of apparatus 100 and systems 160 are intended to provide a general understanding of the structure of various embodiments, and are not intended to serve as a complete description of all the elements and features of apparatus and systems that might use the structures described herein.

Applications that may include the novel apparatus and systems of various embodiments include electronic circuitry used in high-speed computers, communication and signal processing circuitry, modems, single processor modules, multi-processor modules, embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others.

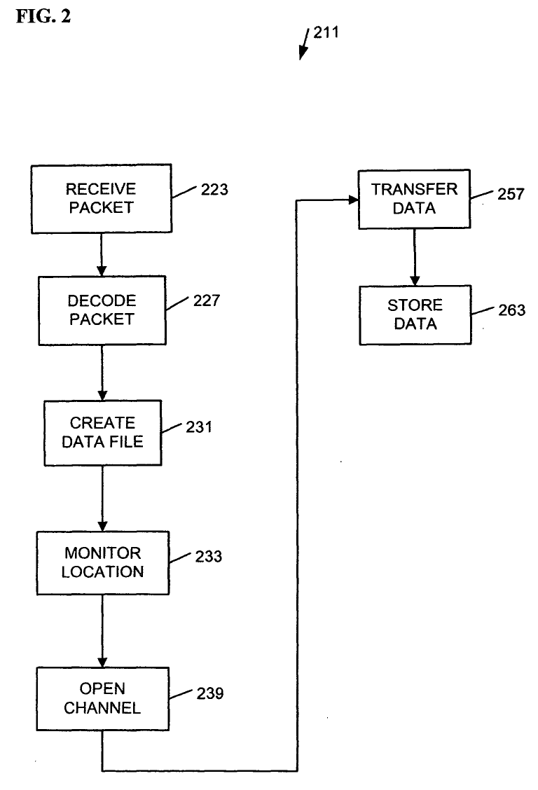

Some embodiments may include a number of methods. For example, FIG. 2 is a flow diagram illustrating several methods 211 according to various embodiments of the invention. A method 211 may begin by receiving one or more data packets from a first network at a first device coupled to the first network as a network node, at block 223. The method 211 may continue with decoding the packets (e.g., filtering one or more protocol elements from the packets) to isolate one or more data fields, at block 227.

The method 211 may include creating a data file comprising at least the data fields in a selected storage location on the first device, at block 231. The data fields associated with the received packets may thus be stored in the selected storage location, perhaps in a selected directory, for example, including a file system directory. The method 211 may also include monitoring the selected storage location (e.g., the selected directory) to detect that the data file has been created, that the data file has reached a selected file size threshold, or that some other condition has been satisfied to indicate that the data file is ready to transfer, at block 233.

The method 211 may further include opening a communications channel across a wired communications link, duplex or simplex, to initiate a secure file transfer, at block 239. The method 211 may continue with transferring the data file from the first device to a second device across the wired communications link coupling the first device to the second device, at block 257. The devices may utilize a communications protocol to effectuate the transfer with characteristics including being non-packetized, unroutable, non-switchable, error-corrected, and not associated with a network protocol stack (e.g., Kermit). The second device may comprise a node on a second network. The method 211 may conclude with storing the data file on the second device, at block 263.

Since an unauthorized intrusion into a secure network from an insecure network may be enabled by switching packets into and within the secure network, a protocol limited to point-to-point communications, as described above, may decrease a likelihood of such unauthorized intrusion.

It should be noted that the methods described herein do not have to be executed in the order described, or in any particular order. Moreover, various activities described with respect to the methods identified herein can be executed in repetitive, serial, or parallel fashion. Information, including parameter values, commands, operands, and other data, can be sent and received in the form of one or more carrier waves.

A software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment. Thus, other embodiments may be realized.

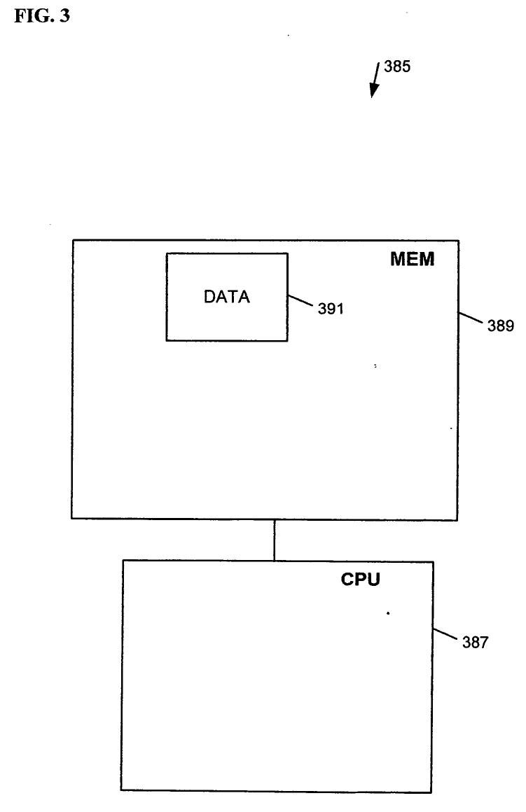

FIG. 3 is a block diagram of an article 385 according to various embodiments of the invention. Such embodiments may include a computer, a memory system, a magnetic or optical disk, some other storage device, and any type of electronic device or system. The article 385 may include one or more processors 387 coupled to a machine-accessible medium such as a memory 389 (e.g., a memory including an electrical, optical, or electromagnetic conductor) having associated information 391 (e.g., computer program instructions, data or both) which, when accessed, results in a machine (e.g., the one or more processors 387) performing such actions as storing in a data file a data field associated with one or more data packets received and decoded at a node on a first network. Other actions may include transferring the data file between the node on the first network and a node on a second network across a wired communications link, duplex or simplex, utilizing a file transfer protocol not associated with a network protocol stack.

Implementing the apparatus, systems, and methods disclosed herein may operate to reduce the likelihood of unauthorized intrusion into a secure network across a file transfer facility linking an insecure network (e.g., a wireless sensor network) to a node on the secure network.

Although the inventive concept may be described in the exemplary context of an 802.xx implementation (e.g., 802.11a, 802.11g, 802.11HT, 802.16, etc.), the claims are not so limited. Embodiments of the present invention may well be implemented as part of any wired or wireless system Examples may also include embodiments comprising multi-carrier wireless communication channels (e.g., orthogonal frequency-division multiplexing (OFDM), discrete multi-tone modulation (DMT), etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention,” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, including:
receiving at least one data packet from a first network at a first device coupled as a network node on the first network;
decoding the at least one data packet to isolate a data field;
creating a data file comprising the data field in a selected storage location on the first device;
monitoring the selected storage location to detect that the data file has been created;
transferring the data file from the first device to a second device comprising a node on a second network, across a wired communications link coupling the first device to the second device, utilizing an error-corrected file transfer protocol not associated with a network protocol stack; and
storing the data file on the second device.

2. The method of claim 1, further including:
opening a communications channel across the wired communications link to initiate a secure file transfer.

3. The method of claim 1, wherein decoding the at least one data packet further includes:
filtering at least one protocol element from the at least one data packet to isolate the data field.

4. A method, including:
storing in a data file a data field associated with at least one data packet received at a node on a first network; and
transferring the data file between the node on the first network and a node on a second network across a wired communications link utilizing a file transfer protocol not associated with a network protocol stack.

5. The method of claim 4, wherein the file transfer protocol comprises a non-packetized, unroutable, and non-switchable protocol.

6. The method of claim 4, wherein the file transfer protocol comprises an error-corrected protocol.

7. The method of claim 4, further including:
decoding the at least one data packet to isolate the data field.

8. The method of claim 4, further including:
creating the data file in a selected directory.

9. The method of claim 8, further including:
monitoring the selected directory to detect that the data file has been created.

10. The method of claim 8, further including:
storing the data file on the node on the second network.

11. An article including a machine-accessible medium having associated information, wherein the information, when accessed, results in a machine performing:
storing in a data file a data field associated with at least one data packet received at a node on a first network; and
transferring the data file between the node on the first network and a node on a second network across a wired communications link utilizing a file transfer protocol not associated with a network protocol stack.

12. The article of claim 11, wherein the information, when accessed, results in a machine performing:
decoding the at least one data packet to isolate the data field.

13. The article of claim 11, wherein the wired communications link comprises a duplex link.

14. An apparatus, including:
a sender module to transfer a stored data file, including a data field associated with at least one data packet received at a node on a first network, between the node on the first network and a node on a second network utilizing a file transfer protocol not associated with a network protocol stack;
a filter coupled to the sender module to isolate the data field from at least one protocol element associated with the at least one data packet; and
a receiver module coupled to the sender module to receive the data file.

15. The apparatus of claim 14, further including:
at least one programmable logic controller coupled to the sender module to provide the at least one data packet.

16. The apparatus of claim 14, further including:
a polled directory coupled to the sender module to receive and store the data file for subsequent transmission.

17. The apparatus of claim 14, wherein the first network comprises a wireless sensor network.

18. The apparatus of claim 17, wherein the wireless sensor network exchanges data packets according to an Institute of Electrical and Electronic Engineers (IEEE) 802.11 specification.

19. A system, including:
a sender module to transfer a stored data file, including a data field associated with at least one data packet received at a node on a first network, between the node on the first network and a node on a second network utilizing a file transfer protocol not associated with a network protocol stack;
a filter coupled to the sender module to isolate the data field from at least one protocol element associated with the at least one data packet;
a receiver module to receive the stored data file; and
a wired communications link to couple the sender module to the receiver module.

20. The system of claim 19, further including:
a secure port associated with at least one of the sender module and the receiver module, coupled to the wired communications link and accessible only by an application implementing the file transfer protocol.

21. The system of claim 20, wherein the secure port comprises a universal serial bus port.

22. The system of claim 20, wherein the secure port utilizes Electronic Industries Association 232 standard voltage levels and signaling.

23. The system of claim 19, wherein the wired communications link comprises one of a twisted pair medium and a coaxial cable.
